(19) United States
(12) Patent Application Publication
(10) Pub. No.: US 2024/0418614 A1
(43) Pub. Date: Dec. 19, 2024

(54) MEASURING METHOD AND PEELING METHOD

(71) Applicant: Yamaha Robotics Holdings Co., Ltd., Tokyo (JP)

(72) Inventors: Yuta Tobari, Tokyo (JP); HIROSHI KIKUCHI, Tokyo (JP); Hayato Hishinuma, Tokyo (JP)

(73) Assignee: Yamaha Robotics Holdings Co., Ltd., Tokyo (JP)

(21) Appl. No.: 18/731,383

(22) Filed: Jun. 3, 2024

(30) Foreign Application Priority Data
Jun. 13, 2023 (JP) 2023-097121

(51) Int. Cl. G01N 3/08

(52) U.S. Cl. CPC G01N 3/08; G01N 2203/0091; G01N 2203/0282; G01N 2203/0682

(57) ABSTRACT

The present invention provides a measuring method for measuring a bonding strength, including: preparing a semiconductor chip bonded to a main surface of a substrate, the semiconductor chip having an outer edge chamfered to a curved surface that is a convex portion toward an outside; inserting a blade along the main surface towards the outer edge of the semiconductor chip and peeling the semiconductor chip from the substrate by bringing an inclined surface of the blade into contact with the curved surface of the outer edge of the semiconductor chip and applying force to the semiconductor chip in a direction away from the substrate; and measuring a bonding strength between the substrate and the semiconductor chip based on a length from a contact point where the blade contacts the semiconductor chip to a point where the semiconductor chip and the substrate are separated.

### CROSS-REFERENCE TO RELATED APPLICATION

This application claims the priority benefits of Japanese application no. 2023-097121, filed on Jun. 13, 2023. The entirety of the above-mentioned patent application is hereby incorporated by reference herein and made a part of this specification.

### BACKGROUND

### Technical Field

The present invention relates to a measuring method and a peeling method.

### Related Art

A method is known in which a blade is inserted into the bonding surface of two bonded substrates to separate the substrates, and the bonding strength is measured based on the peeling length. For example, Patent Document 1 (Japanese Patent No. 4348454) discloses that the bonding strength of a substrate is evaluated by such a blade insertion method. Specifically, the bonding strength of the substrate may be evaluated from values such as the length of the crack between the substrates caused by peeling the substrates, the thickness of the blade, and the thickness of each of the two substrates.

However, when performing the blade insertion method using a single-edged blade on the bonding surface of such two substrates, there are situations in which it is difficult for substrates to separate from each other, such as when the bond between the substrates is strong, or when the substrates try to rejoin each other even after separation.

The present invention has been made in view of these circumstances and provides a measuring method and a peeling method for easily peeling a semiconductor chip from a substrate.

### SUMMARY

The measuring method according to one aspect of the present invention is a measuring method for measuring a bonding strength by peeling off a semiconductor chip bonded to a main surface of a substrate using a blade with a blade angle of an acute angle, including: preparing a semiconductor chip bonded to a main surface of a substrate, the semiconductor chip having an outer edge chamfered to a curved surface that is a convex portion toward an outside; inserting a blade, having a blade angle of an acute angle, along the main surface towards the outer edge of the semiconductor chip and peeling the semiconductor chip from the substrate by bringing an inclined surface of the blade into contact with the curved surface of the outer edge of the semiconductor chip and applying force to the semiconductor chip in a direction away from the substrate; and measuring a bonding strength between the substrate and the semiconductor chip based on a length from a contact point where the blade contacts the semiconductor chip to a point where the semiconductor chip and the substrate are separated.

According to this aspect, for the semiconductor chip bonded to the main surface of the substrate, the blade is inserted along the main surface toward the outer edge chamfered to the curved surface of the semiconductor chip, the inclined surface of the blade is brought into contact with the curved surface of the outer edge of the semiconductor chip, and the semiconductor chip is peeled off. At this time, the inclined surface of the blade and the curved surface of the semiconductor chip may make line contact in the width direction to reduce the contact area. As a result, the friction between the inclined surface of the blade and the curved surface of the semiconductor chip is reduced, and the semiconductor chip is easily separated from the substrate. Therefore, the bonding strength of the two may be easily measured.

According to the present invention, a measuring method and a peeling method for easily peeling a semiconductor chip from a substrate are provided.

### BRIEF DESCRIPTION OF THE DRAWINGS

FIG. 1 is a cross-sectional view showing an example of the semiconductor module to which the measuring method according to the first embodiment is applicable.

FIG. 2 is a block diagram showing an example of the peeling strength measuring apparatus used in the measuring method according the first embodiment.

FIG. 3 is a perspective view showing an example of the blade used in the measuring method according to the first embodiment.

FIG. 4 is a flowchart showing the measuring method according to the first embodiment.

FIG. 5 is a diagram showing an example of executing the measuring method according to the first embodiment.

FIG. 6A is a cross-sectional view showing an example of the measuring method according to the first embodiment being executed.

FIG. 6B is a cross-sectional view showing an example of the measuring method according to the first embodiment being executed.

FIG. 6C is a cross-sectional view showing an example of the measuring method according to the first embodiment being executed.

FIG. 6D is a cross-sectional view showing an example of the measuring method according to the first embodiment being executed.

### DESCRIPTION OF THE EMBODIMENTS

Hereinafter, the embodiment of the present invention will be described with reference to the drawings. The drawings of this embodiment are illustrative, the dimensions and shapes of each part are schematic, and the technical range of the present invention should not be interpreted as being limited to the embodiment.

### First Embodiment

In FIG. 1, in order to describe the relative directional relationships, the direction to the right of the page is referred to as the X-axis positive direction, the direction to the back of the page is referred to as the Y-axis positive direction, and the direction to the top of the page is referred to as the Z-axis positive direction. In addition, the direction to the left of the page is referred to as the X-axis negative direction, the direction to the front of the page is referred to as the Y-axis negative direction, and the direction to the bottom of the page is referred to as the Z-axis negative direction.

FIG. 1 is a cross-sectional view showing an example of the semiconductor module to which the measuring method according to the first embodiment of the present invention is applicable. The semiconductor module 1 includes a semiconductor wafer 2 and a semiconductor chip 3. The outer edge 3a of the semiconductor chip 3 is chamfered to the curved surface 3b. The curved surface 3b is chamfered to form a convex portion toward the outside of the semiconductor chip 3 (in the positive and negative directions of the X-axis). It is noted that the back surface 3c of the semiconductor chip 3 may be bonded to the main surface 2a of the semiconductor wafer 2 by electrostatic force. In the following description, the semiconductor wafer 2 is used as an example of a substrate that is applicable to the measuring method according to the first embodiment of the present invention, however, in addition to various metals and alloys, the substrate may also be made of glass, ceramics, resin, etc.

### <Peeling Strength Measuring Apparatus Used in Measuring Method Related to First Embodiment>

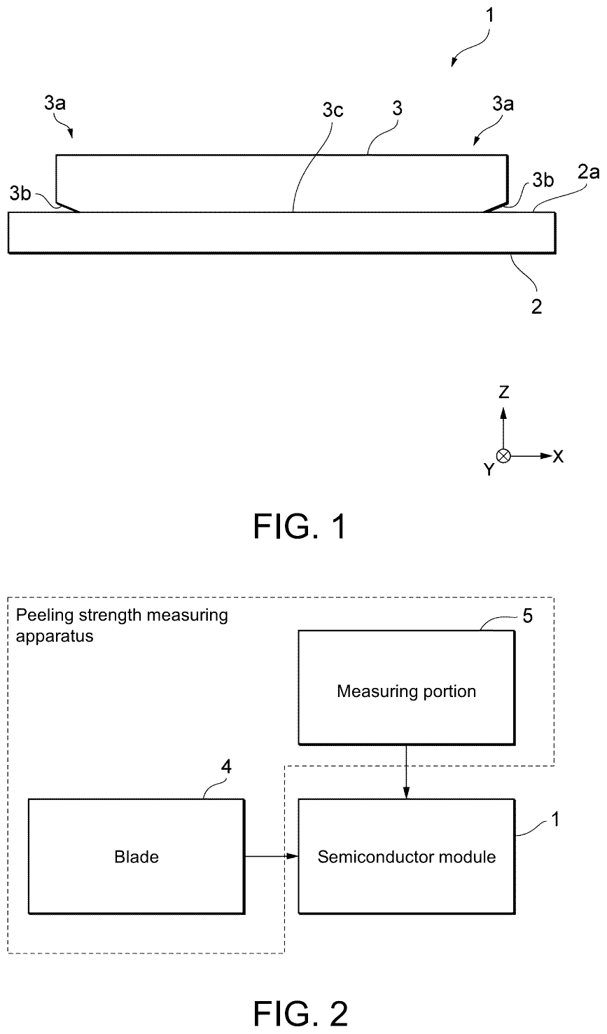

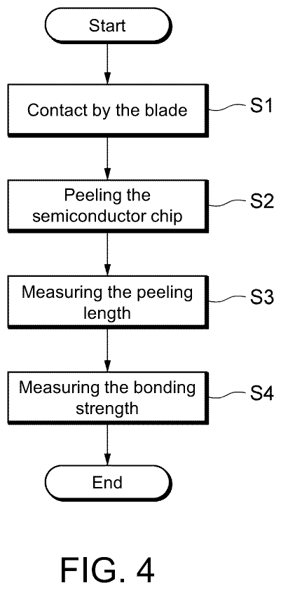

FIG. 2 is a block diagram showing an example of the peeling strength measuring apparatus used in the measuring method according the first embodiment. The peeling strength measuring apparatus according to the first embodiment includes a blade 4 that peels off the semiconductor chip 3 from the semiconductor wafer 2 and a measuring portion 5 that measures the bonding strength between the semiconductor wafer 2 and the semiconductor chip 3. It is assumed that steps S1 to S4 shown in FIG. 4, which will be described later, are performed using the peeling strength measuring apparatus according to the first embodiment. It is noted that the measuring portion 5 may be a measuring apparatus including, for example, an edge sensor, a surface potential measuring sensor, etc.

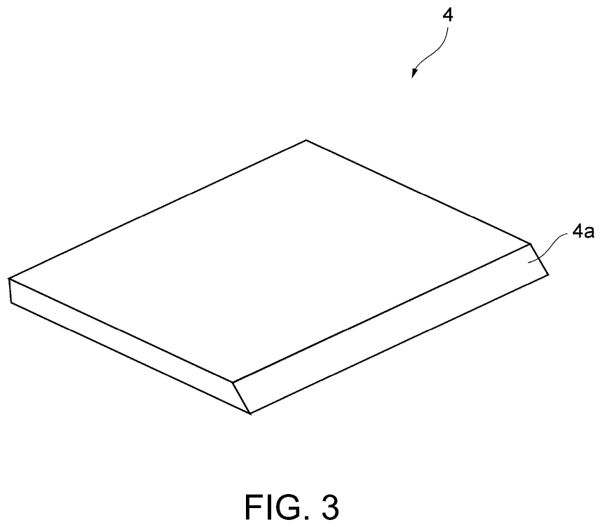

FIG. 3 is a perspective view showing an example of the blade used in the measuring method according to the first embodiment of the present invention. The blade 4 has an inclined surface 4a with respect to the bottom surface. It is noted that the blade 4 may be used by being fixed to a fixing member (not shown). Such a configuration prevents the blade 4 from buckling. It is noted that the inclined surface 4a is a flat surface.

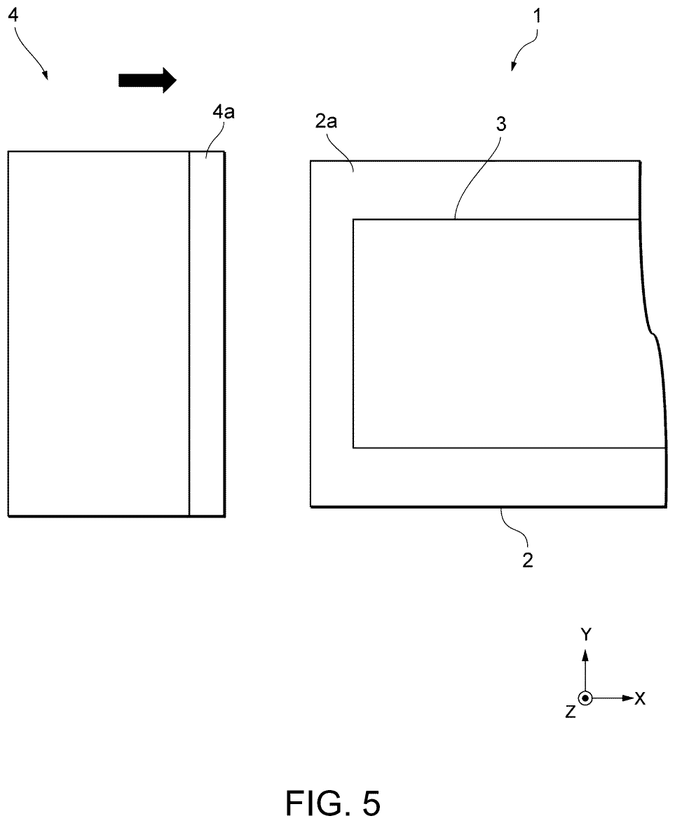

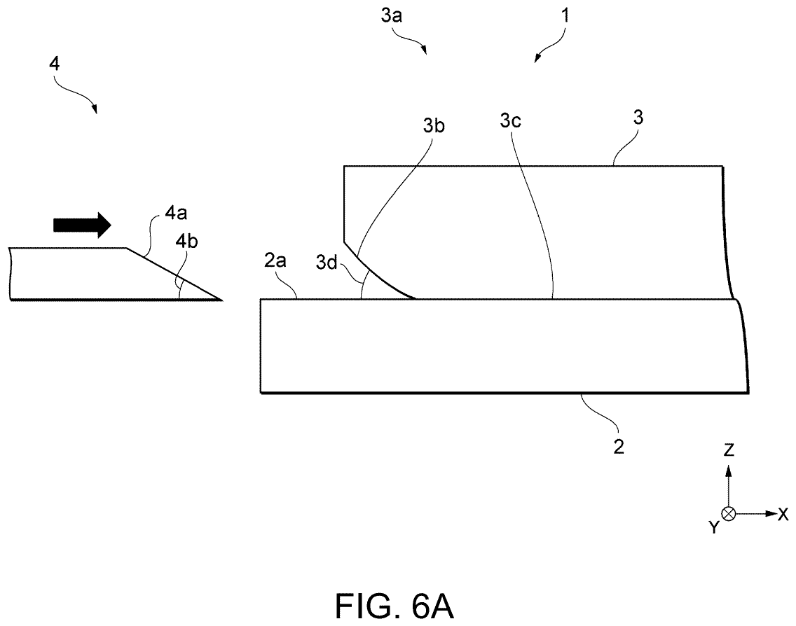

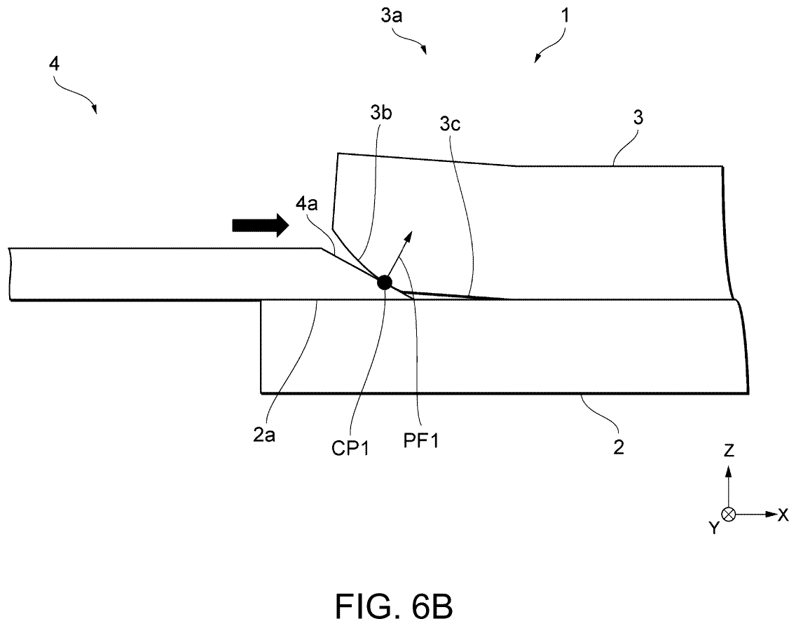

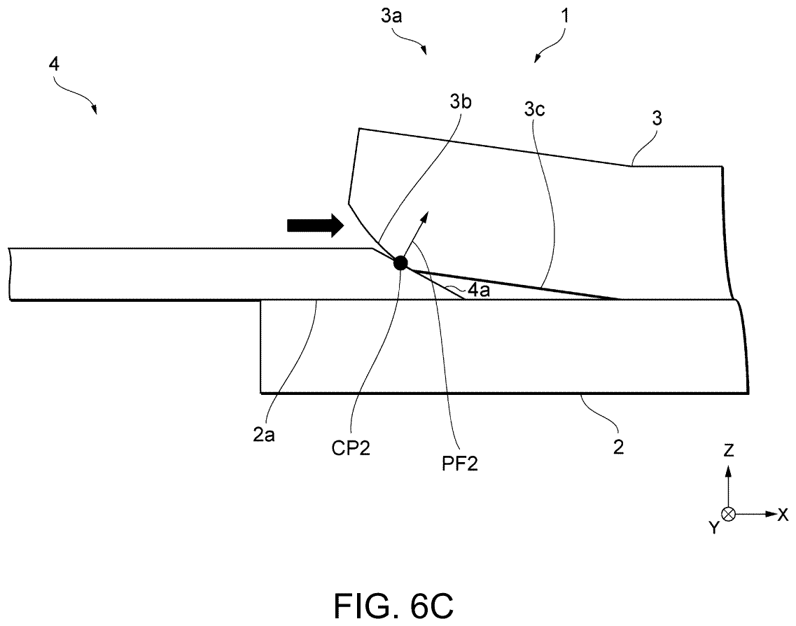

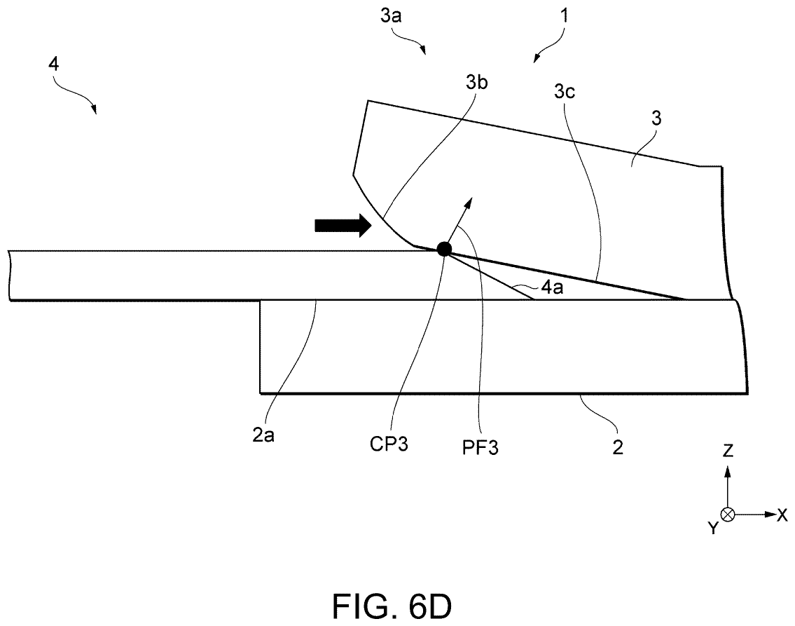

FIG. 4 is a flowchart showing the measuring method according to the first embodiment of the present invention. The measuring method according to the first embodiment of the present invention proceeds along steps S1 to S4. The flowchart will be described below with appropriate reference to FIG. 5 and FIGS. 6A to 6D.

FIG. 5 is a diagram showing an example of executing the measuring method according to the first embodiment of the present invention. The blade 4 is inserted into the semiconductor module 1 in the insertion direction (X-axis positive direction). The length in the width direction (Y-axis positive direction) of the blade 4 may be greater than the length in the width direction (Y-axis positive direction) of the outer edge 3a chamfered to the curved surface 3b of the semiconductor chip 3. With this configuration, the contact area is small in the width direction (Y-axis positive direction) of the curved surface 3b of the semiconductor chip 3, and peeling is performed by making a line contact with the surface as a whole, so that peeling may be performed with less friction.

FIG. 6A is a cross-sectional view showing an example of the measuring method according to the first embodiment being executed. The blade 4 is inserted toward the outer edge 3a of the semiconductor chip 3, which is chamfered to the curved surface 3b. That is, the inclined surface 4a of the blade 4, which has a blade angle of an acute angle 4b, is inserted in the X-axis positive direction along the main surface 2a toward the gap 3d between the curved surface 3b and the main surface 2a.

The blade angle of the acute angle 4b of the blade 4 may be used, for example, as long as the blade angle is 45° or less. Furthermore, a blade of 10° or more and 20° or less may be used. By setting the angle of the blade to 45° or less, the blade 4 may more easily enter between the semiconductor chip 3 and the semiconductor wafer 2, and by making the contact point between the inclined surface 4a of the blade 4 and the curved surface 3b of the semiconductor chip 3 on the curved surface 3b close to the bonding surface between the semiconductor wafer 2 and the semiconductor chip 3, it is easier to apply force to the semiconductor chip 3 in the direction away from the semiconductor wafer 2. It is noted that the combination of the angle of the blade 4 and the curvature of the curved surface 3b shown in FIG. 6A is an example, and other combinations may be adopted.

FIG. 6B is a cross-sectional view showing an example of the measuring method according to the first embodiment being executed. When the blade 4 is inserted into the outer edge 3a, the inclined surface 4a of the blade 4 comes into contact with the curved surface 3b of the semiconductor chip 3 at the contact point CP1 and makes a line contact along the Y-axis positive direction. At this time, a peeling force PF1 acts in a direction perpendicular to the inclined surface 4a of the blade 4 (in a direction between the X-axis positive direction and the Z-axis positive direction), thereby peeling the semiconductor chip 3 from the main surface 2a of the semiconductor wafer 2.

In step S1, the blade 4 is brought into contact. As shown in FIG. 6B, the inclined surface 4a of the blade 4 is brought into contact with the curved surface 3b of the outer edge 3a of the semiconductor chip 3.

In step S2, the semiconductor chip 3 is peeled off. The semiconductor chip 3 is gradually peeled off from the main surface 2a of the semiconductor wafer 2 by advancing the blade 4 in the X-axis positive direction in the order of FIGS. 6B, 6C, and 6D.

FIG. 6C is a cross-sectional view showing an example of the measuring method according to the first embodiment being executed. The inclined surface 4a of the blade 4 comes into contact with the curved surface 3b of the semiconductor chip 3 at the contact point CP2 and makes a line contact along the Y-axis positive direction. At this time, a peeling force PF2 acts in a direction perpendicular to the inclined surface 4a of the blade 4 (in a direction between the X-axis positive direction and the Z-axis positive direction), thereby peeling the semiconductor chip 3 from the main surface 2a of the semiconductor wafer 2.

FIG. 6D is a cross-sectional view showing an example of the measuring method according to the first embodiment being executed. The inclined surface 4a of the blade 4 comes into contact with the back surface 3c of the semiconductor chip 3 at the contact point CP3 and makes a line contact along the Y-axis positive direction. At this time, a peeling force PF3 acts in a direction perpendicular to the inclined surface 4a of the blade 4 (in a direction between the X-axis positive direction and the Z-axis positive direction), thereby peeling the semiconductor chip 3 from the main surface 2a of the semiconductor wafer 3. Thereafter, the semiconductor chip 3 is gradually peeled off from the main surface 2a of the semiconductor wafer 2 by advancing the blade 4 in the X-axis positive direction.

In step S3, the peeling length is measured. In FIG. 6D, for example, the length from the contact point CP3 between the upper end of the inclined surface 4a of the blade 4 and the back surface 3c of the semiconductor chip 3 to the point where the semiconductor chip 3 and the semiconductor wafer 2 are separated is measured.

In step S4, the bonding strength is measured. The bonding strength may be calculated using, for example, the thickness of blade 4, the thickness of semiconductor chip 3, and the peeling length measured in step S3, which are obtained in advance. The bonding strength may be measured, for example, in a measuring portion 5 including an edge sensor, a surface potential measuring sensor, etc. (not shown).

The bonding strength between the semiconductor chip 3 and the semiconductor wafer 2 may be evaluated using the bonding energy of the bonding surface. The bonding energy may be calculated using the following formula.

$$γ = \frac{3 E * {u}^{2} {w}^{3}}{32 {l}^{4}}$$

The bonding energy y is determined such that: u=total thickness of the blade, l=peeling length, w=thickness of the semiconductor chip, and the Young's modulus E*.

According to the above aspect, by chamfering the outer edge 3a of the semiconductor chip 3 to the curved surface 3b and by setting the blade 4 to the inclined surface 4a, the contact area between the blade 4 and the semiconductor chip 3 is reduced, and the friction is reduced, which makes it easier to enter. By using such a blade 4, the semiconductor chip 3 whose curved surface 3b has been chamfered may be easily separated from the semiconductor wafer 2.

The measuring method according to the first embodiment of the present invention has been described above. The peeling method of the embodiment according to the present invention will be described using FIG. 1 to FIG. 6D, which are related to the measuring method of the first embodiment.

### <Example of Peeling Method of Embodiment According to the Present Invention>

As an example of the peeling method according to the embodiment of the present invention, the peeling method may be performed using the semiconductor module 1, the measuring portion 5, and the blade 4 shown in FIG. 1, FIG. 2, and FIG. 3. An example of the peeling method according to the embodiment of the present invention is performed in the order of steps S1 and S2 shown in FIG. 4, similarly to the measuring method according to the first embodiment. In an example of the peeling method according to the embodiment of the present invention, the semiconductor chip 3 may be completely peeled off from the main surface 2a of the semiconductor wafer 2 by moving the blade 4 in the X-axis positive direction as shown in FIG. 6D.

It is noted that the first embodiment described above is intended to facilitate understanding of the present invention, and is not intended to be interpreted as limiting the present invention. The present invention may be modified/improved without departing from its spirit, and the present invention also includes equivalents thereof. That is, the range of the present invention includes the first embodiment with appropriate design changes made by a person skilled in the art as long as it has the characteristics of the present invention. For example, each element provided in the first embodiment and its configuration, material, conditions, shape, size, etc. are not limited to those illustrated and may be changed as appropriate. Moreover, each element provided in the first embodiment may be combined to the extent technically possible, and combinations of these are also included in the range of the present invention as long as they include the features of the present invention.

### (Appendix 1)

The measuring method according to this embodiment is a measuring method for measuring a bonding strength by peeling off a semiconductor chip bonded to a main surface of a substrate using a blade with a blade angle of an acute angle, including: preparing a semiconductor chip bonded to a main surface of a substrate, the semiconductor chip having an outer edge chamfered to a curved surface that is a convex portion toward an outside; inserting a blade, having a blade angle of an acute angle, along the main surface towards the outer edge of the semiconductor chip and peeling the semiconductor chip from the substrate by bringing an inclined surface of the blade into contact with the curved surface of the outer edge of the semiconductor chip and applying force to the semiconductor chip in a direction away from the substrate; and measuring a bonding strength between the substrate and the semiconductor chip based on a length from a contact point where the blade contacts the semiconductor chip to a point where the semiconductor chip and the substrate are separated.

### (Appendix 2)

In the measuring method described in Appendix 1, the acute angle of the blade is 45° or less and 10° or more.

### (Appendix 3)

In the measuring method described in Appendix 1 or Appendix 2, a length in a width direction of the inclined surface of the blade is greater than a length in a width direction of the curved surface of the semiconductor chip.

### (Appendix 4)

In the measuring method described in any one of Appendix 1 to 3, the substrate is a semiconductor wafer.

### (Appendix 5)

In the measuring method described in any one of Appendix 1 to 4, the measuring method includes peeling off the semiconductor chip bonded to the main surface of the substrate by electrostatic force.

### (Appendix 6)

The peeling method according to this embodiment includes: preparing a semiconductor chip bonded to a main surface of a substrate, the semiconductor chip having an outer edge chamfered to a curved surface that is a convex portion toward an outside; and inserting a blade, having a blade angle of an acute angle, along the main surface towards the outer edge of the semiconductor chip and peeling the semiconductor chip from the substrate by bringing an inclined surface of the blade into contact with the curved surface of the outer edge of the semiconductor chip and applying force to the semiconductor chip in a direction away from the substrate.

What is claimed is:

1. A measuring method for measuring a bonding strength by peeling off a semiconductor chip bonded to a main surface of a substrate using a blade with a blade angle of an acute angle, the measuring method comprising:
preparing a semiconductor chip bonded to a main surface of a substrate, the semiconductor chip having an outer edge chamfered to a curved surface that is a convex portion toward an outside;
inserting the blade along the main surface towards the outer edge of the semiconductor chip and peeling the semiconductor chip from the substrate by bringing an inclined surface of the blade into contact with the curved surface of the outer edge of the semiconductor chip and applying force to the semiconductor chip in a direction away from the substrate; and
measuring a bonding strength between the substrate and the semiconductor chip based on a length from a contact point where the blade contacts the semiconductor chip to a point where the semiconductor chip and the substrate are separated.

2. The measuring method according to claim 1, wherein the acute angle of the blade is 45° or less and 10° or more.

3. The measuring method according to claim 1, wherein a length in a width direction of the inclined surface of the blade is greater than a length in a width direction of the curved surface of the semiconductor chip.

4. The measuring method according to claim 1, wherein the substrate is a semiconductor wafer.

5. The measuring method according to claim 2, wherein the substrate is a semiconductor wafer.

6. The measuring method according to claim 3, wherein the substrate is a semiconductor wafer.

7. The measuring method according to claim 1, wherein the measuring method comprises peeling off the semiconductor chip bonded to the main surface of the substrate by electrostatic force.

8. The measuring method according to claim 2, wherein the measuring method comprises peeling off the semiconductor chip bonded to the main surface of the substrate by electrostatic force.

9. The measuring method according to claim 3, wherein the measuring method comprises peeling off the semiconductor chip bonded to the main surface of the substrate by electrostatic force.

10. A peeling method, comprising:
preparing a semiconductor chip bonded to a main surface of a substrate, the semiconductor chip having an outer edge chamfered to a curved surface that is a convex portion toward an outside; and
inserting a blade, having a blade angle of an acute angle, along the main surface towards the outer edge of the semiconductor chip and peeling the semiconductor chip from the substrate by bringing an inclined surface of the blade into contact with the curved surface of the outer edge of the semiconductor chip and applying force to the semiconductor chip in a direction away from the substrate.
